(19) United States
(12) Patent Application Publication
(10) Pub. No.: US 2009/0249311 A1
(43) Pub. Date: Oct. 1, 2009

(54) SHARING A NATIVE MODULE OF COMPILED CODE USING AN ABSTRACTION MODULE OF INTERPRETED CODE IN A VIRTUAL MACHINE ENVIRONMENT

(75) Inventors: Sunil K. DANDAMUDI, Coconut Creek, FL (US); Suneeta KOGANTI, Coconut Creek, FL (US); Roberto VILA, Hollywood, FL (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 12/059,854

(22) Filed: Mar. 31, 2008

(51) Int. Cl. G06F 9/44

(52) U.S. Cl. 717/139

(57) ABSTRACT

Interpreted code modules configured to be executed within a virtual machine can be identified. Each of the interpreted code modules can be configured to interact with a native module such that dependency information for the native module can be programmatically utilized by each of the interpreted code modules. An abstraction module for the virtual machine written in the interpreted language can be established. The abstraction module can be configured to load an instance of the native module, wherein upon loading the instance of the native module the abstraction module is exposed to the dependency information associated with the instance of the native module. Each of the interpreted code modules can be configured to interact with the native mode module through the abstraction module. The abstraction module is configured to provide the dependency information associated with the instance of the native module to each of the interpreted code modules.

### BACKGROUND OF THE INVENTION

The present invention relates to the field of using native code within a virtual machine, and, more particularly, to sharing a native module of compiled code using an abstraction module of interpreted code in a virtual machine environment.

A JAVA-based plug-in environment, such as ECLIPSE or KDEVELOP, is a software system architecture utilizing the JAVA programming language whose functionality is expanded through the use of plug-ins. A JAVA plug-in is a software application written in the JAVA programming language and is designed to be easily integrated into a JAVA-based plug-in environment or another JAVA application to provide additional features and/or functions. For example, IBM's RATIONAL APPLICATION DEVELOPER is a plug-in that provides a JAVA integrated development environment (IDE) for ECLIPSE. The use of plug-ins and plug-in environments provides a high-level of versatility and customization to a computing system.

However, the level of versatility provided by a JAVA-based plug-in environment is severely hindered when multiple JAVA plug-ins need to access the same native code library. Two main approaches have evolved in an attempt to combat this issue. One approach is to partition the procedures being utilized by each JAVA plug-in. For example, placing procedures A and B in a library named “AB.dll” and procedures C, D, and E in a library named “CDE.dll”. This approach requires in-depth knowledge of which procedures are called by each plug-in. Further, this approach is only viable when the plug-ins do not call the same procedure from the native library.

The second approach is illustrated by system 100 of FIG. 1 (Prior Art). In this approach, the JAVA-based plug-in run-time environment 105 contains a centralized native library loader 130 to handle the loading of the native code module 135. The centralized native code library loader 130 can represent a JAVA class that, when instantiated by the JAVA-based plug-in run-time environment 105, loads the native code module 135. Further, the centralized native library loader 130 can wrap the procedure call to a specific procedure of the native code module 135 in a JAVA method using the key word NATIVE.

When the centralized native library loader 130 loads the native code module 135, the JAVA virtual machine (JVM) 110 records that the classloader of the centralized native library loader 130 loaded the native code module 135 in its list of loaded libraries 125, as shown in table 127. Both plug-in A 115 and plug-in B 120 can call the JAVA method of the centralized native library loader 130 to execute the procedure of the native code module 135.

Although this approach allows for multiple plug-ins 115 and 120 to utilize the same procedure contained in a native code module 135, the native code module 135 is not considered to be shared because the JVM 110 only recognizes the native code module 135 in association with the centralized native library loader 130. Creating two different instances of the module 135, each for use by a plug-in 115 and 120 can result in dependency problems and can needless consume computing resources.

### BRIEF SUMMARY OF THE INVENTION

One aspect of the present invention can include a method, apparatus, computer program product, and system for sharing compiled native code with a plurality of interactive interpreted code modules. Interpreted code modules configured to be executed within a virtual machine can be identified. Each of the interpreted code modules can be written in an interpreted language that an interpreter of the virtual machine is able to utilize. A native module that includes compiled native code can be identified. Each of the interpreted code modules can be configured to interact with the native module such that dependency information for the native module can be programmatically utilized by each of the interpreted code modules. An abstraction module for the virtual machine written in the interpreted language can be established. The abstraction module can be configured to load an instance of the native module, wherein upon loading the instance of the native module the abstraction module is exposed to the dependency information associated with the instance of the native module. Each of the interpreted code modules can be configured to interact with the native mode module through the abstraction module. The abstraction module is configured to provide the dependency information associated with the instance of the native module to each of the interpreted code modules.

Another aspect of the present invention can include a system for sharing a compiled native code module with interpreted modules executing in a virtual machine environment that includes an abstraction module and two or more interpreted code modules. The abstraction module can cause the interpreter to load an instance of a native module written in a compiled language so that the dependency information associated with the instance is exposed to the abstraction module. The interpreted code modules can cause the interpreter to interact with a single instance of the native module through the abstraction module. The abstraction module can provide the exposed dependency information associated with the single instance to each of the interpreted code modules.

### BRIEF DESCRIPTION OF THE SEVERAL VIEWS OF THE DRAWINGS

FIG. 1 (Prior Art) is a schematic diagram of a JAVA-based plug-in run-time environment used to handle the loading of the native code module.

FIG. 2 is a schematic diagram illustrating a system that enables the sharing of a native code module by multiple plug-ins and within a run-time environment in accordance with embodiments of the inventive arrangements disclosed herein.

FIG. 3 is a flow chart of a method for adapting a JAVA plug-in to share a native code module within a JAVA-based plug-in run-time environment in accordance with an embodiment of the inventive arrangements disclosed herein.

FIG. 4 is a flow chart of a method detailing the interaction of components that allow a JAVA plug-in to share a native code module within a JVM run-time environment in accordance with an embodiment of the inventive arrangements disclosed herein.

FIG. 5 is a collection of sample code elements illustrating the components that allow a JAVA plug-in to share a native code library within a JAVA-based plug-in run-time environment in accordance with an embodiment of the inventive arrangements disclosed herein.

### DETAILED DESCRIPTION OF THE INVENTION

The present invention teaches a use of an abstraction module to facilitate the sharing of native code among two or more interpreted code modules in a virtual environment. More specifically, the abstraction module loads a single instance of the native code and exposes the instantiated version of the native code to other code modules (interpreted code modules) executing within the virtual machine. These code modules can access the native code exclusively through the abstraction module. This resolves dependency and resource issues with creating two instances of the native code.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

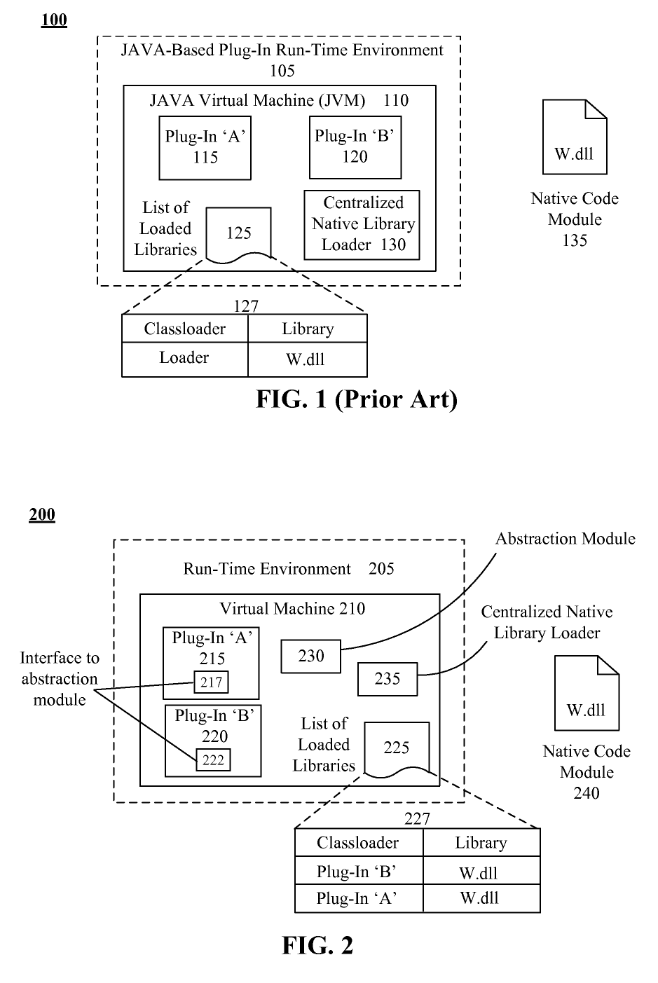

FIG. 2 is a schematic diagram illustrating a system 200 that enables the sharing of a native code module 240 by multiple plug-ins 215 and 220 within a run-time environment 205 in accordance with embodiments of the inventive arrangements disclosed herein. System 200 can resolve the problem of classloader association encountered in system 100 of FIG. 1 through the introduction of new code elements and the restructuring of method calls. System 200 does not require any modification to the actual JAVA-based plug-in run-time environment 205 or native code module 240. It should be noted that the JAVA-based plug-in run-time environment 205 and plug-ins 215 and 220 can include additional elements not shown in FIG. 2, and that only those elements pertinent to the present invention are depicted in system 200.

In system 200, plug-in A 215 and plug-in B 220 can share access to the procedures of the native code module 240. The native code module 240 can include compiled code, which can be accessed through a native code interface, such as the JAVA NATIVE INTERFACE (JNI). From a perspective of environment 210, the native code module 240 can be a dynamic link library (DLL), which is instantiated via the JNI.

System 200 can be built upon system 100 of FIG. 1. Like system 100, system 200 can include a run-time environment 205, a virtual machine 210, plug-ins A 215 and B 220, a centralized native library loader 235, a list of loaded libraries 225, and a native code module 240. System 200 can additionally include an abstraction module 230.

The abstraction module 230 can represent a component configured to load the native code module 240 for each plug-in 215 and 220. The plug-in 215 and 220 and the abstraction module 230 can be written in interpreted code of the virtual machine 210. Each plug-in 215 and 220 can represent any interpreted language module that shares native code module 240. Although two plug-ins 215 and 220 are shown, any number of plug-ins or other interpreted language module can be utilized in system 200. In one embodiment, each module 215, 220, and 230 of code can include JAVA code usable by a JAVA virtual machine 210. The abstraction module 230 can replace the loading function of the centralized native library loader 130 of system 100. Thus, the abstraction module 230 can be alternatively referred to as a native code initializer. Further, this initializer 230 can be implemented as a module 230 or as a component of the environment 210, which can be situationally utilized instead of the standard native loader. Unlike the centralized native library loader 130 of system 100, the abstraction module 230 can be loaded by the classloader of the calling plug-in 212 or 220.

Therefore, when the abstraction module 230 executes code to load the native code module 240 for plug-in A 215, the virtual machine 210 can associate the module 240 with the classloader of plug-in A 215. When plug-in B 220 calls the abstraction module 230, the module 230 can be loaded with the classloader for plug-in B 220. Since the list of loaded libraries 225 managed by the virtual machine 210 does not show the native code module 240 as already having been loaded by plug-in B 220, the native code module 240 can be loaded and associated with the classloader of plug-in B 220. As shown in table 227, the list of loaded libraries contains two records for the loading of the native code module 240, one for each plug-in's 215 and 220 classloader.

At this point, the virtual machine 210 can allow both plug-ins 215 and 220 to share access to the same native code module 240. However, the plug-ins 215 and 220 cannot utilize the centralized native library loader 235, as in system 100, to invoke a procedure of the native code module 240 without the virtual machine 210 throwing an exception, such as an UnsatisfiedLinkError.

Since the centralized native library loader 235 is a component inherited from system 100, it can still contain code that loads the native code module 240 and can provide access to the procedure in the native code module 240. Therefore, the centralized native library loader 235 can require modification to provide functionality within system 200.

Since the abstraction module 230 now performs the function of loading the native code module 240, a modification can be made to the JAVA-based plug-in run-time environment 205 and/or the centralized native library loader 235 to exclude this functionality. For example, if the centralized native library loader 235 is implemented as a JAVA class that automatically loads the native code module 240 upon instantiation, then changes can be made to not instantiate the JAVA class of the centralized native library loader 235. It should be noted that the actual modifications made to the centralized native library loader 235 and/or JAVA-based plug-in run-time environment 205 are dependent upon the implementation of these components 235 and 205.

The JAVA NATIVE method, which calls the procedure from the native code module 240, contained within the centralized native library loader 235 can still be used within system 200. Since multiple plug-ins 215 and 220 need to utilize this JAVA NATIVE method, storing the JAVA NATIVE method in a centralized location can increase accessibility and code reuse.

In order to access the JAVA NATIVE method of the centralized native library loader 235, each plug-in 215 and 220 can be modified to include an interface to the abstraction module 217 and 222, respectively. Interfaces 217 and 222 can represent a JAVA software element designed to specifically access the JAVA NATIVE method of the centralized native library loader 235.

Plug-in A 215 can call the method of its native procedure internal interface 217 to invoke the procedure from the native code module 240. The series of method calls can flow from the plug-in 215/220 to the interface 217/222 to the centralized native library loader 235. Using this approach, the same classloader can be associated with each method call in the series.

System 200 illustrates the sharing of a single native code module 240. When multiple native code modules 240 exist that are shared among a multitude of plug-ins, then the JAVA-based plug-in run-time environment 205 can be expanded to include a abstraction module 230 and centralized native library loader 235 for each native code module 240 being used. Additionally, each plug-in can include multiple native procedure internal interfaces to access the multiple centralized native libraries.

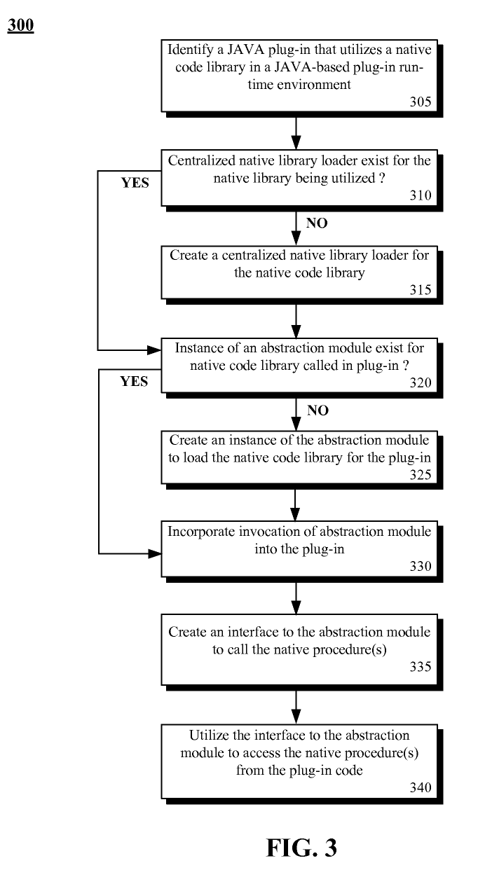

FIG. 3 is a flow chart of a method 300 for adapting a JAVA plug-in to share a native code library (e.g., a native code module) within a JAVA-based plug-in run-time environment in accordance with an embodiment of the inventive arrangements disclosed herein. Method 300 can be performed in the context of system 200 or any other system supporting the sharing of native code modules.

Method 300 can begin with step 305 where a JAVA plug-in that utilizes a native code module can be identified in a JAVA-based plug-in run-time environment. In step 310, it can be determined if a centralized native library loader already exists for the native code library being utilized by the JAVA plug-in.

When a centralized native library loader does not already exist, step 315 can be executed where a centralized native library loader can be created for the native code library. It should be noted that in the context of system 200, the centralized native library loader simply embodies the JAVA method that utilizes the NATIVE key word to call the procedure from the native code library.

After the execution of step 315 or when it is determined that a centralized native library loader already exists for the native code library in step 310, step 320 can determine if an instance of the abstraction module exists for the native code library. An abstraction module can be created to load the native code library for the plug-in in step 325.

After the execution of step 325 or when it is determined that an instance of the abstraction module already exists for the native code library in step 320, step 330 can be executed where the invocation of the abstraction module can be incorporated into the plug-in. For example, the loading process of the plug-in can be modified to include a call to the abstraction module.

In step 335, an interface to the abstraction module can be created to call one or more of the procedures of the native code library from the centralized native library loader. Once created, the interface to the abstraction module can then be utilized to call the procedures of the native code library within the plug-in code.

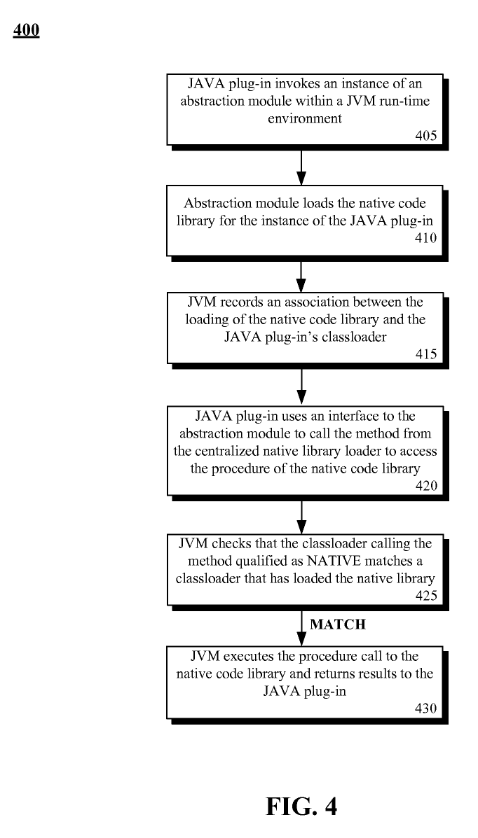

FIG. 4 is a flow chart of a method 400 detailing the interaction of components that allow a JAVA plug-in to share a native code library (e.g., native module) within a JVM run-time environment in accordance with an embodiment of the inventive arrangements disclosed herein. Method 400 can be performed in the context of system 200 and/or in conjunction with method 300.

Method 400 can begin with step 405 where a JAVA plug-in operating in a JAVA-based plug-in run-time environment can invoke an instance of an abstraction module. The abstraction module can load the native code library for the instance of the plug-in in step 410.

In step 415, the JAVA virtual machine (JVM) can record an association between the loading of the native code library and the classloader of the plug-in. The plug-in can use an interface to the abstraction to call the method of the centralized native library loader that, in turn, invokes the procedure of the native code library in step 420.

In step 425, the JVM can check that the classloader calling the method qualified as NATIVE, which can be contained within the centralized native library loader, matches a classloader recorded as having loaded the native code library. When a match is found, the JVM can execute the procedure call to the native code library and can return results to the JAVA plug-in.

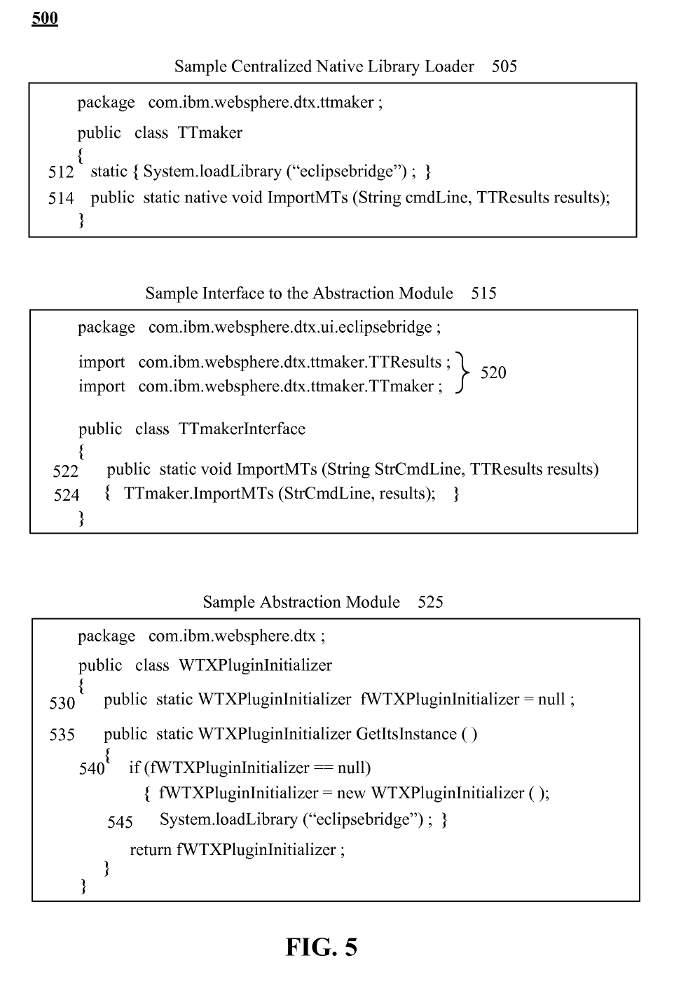

FIG. 5 is a collection 500 of sample code elements 505, 515, and 525 illustrating the components that allow a JAVA plug-in to share a native code library within a JAVA-based plug-in run-time environment in accordance with an embodiment of the inventive arrangements disclosed herein. It should be emphasized that the sample code elements 505, 515, and 525 are for illustrative purposes only and are not meant a limitation to or an absolute implementation of the present invention.

Collection 500 can depict sample code written in the JAVA programming language for a centralized native library loader 505, an interface to an abstraction module 515, and an abstraction module 525. This example pertains to JAVA plug-ins requiring access to a procedure called “ImportMTs” contained within a native code library entitled “eclipsebridge”.

As shown in this example, the sample centralized native library loader 505 can be defined as a JAVA package containing a class called TTmaker. If the TTmaker class is instantiated as a JAVA object, it can execute a static initializing block denoted by line 512 and provide a JAVA method 514 that wraps the ImportMTs procedure from the native code library.

Line 512 can contain a single instruction that loads the native code library, eclipsebridge. Further, the use of the key word static can denote that the centralized native library loader is to attempt to execute line 512 every time the TTmaker class is instantiated. Line 514 can represent the standard method declaration for a procedure that resides in a native code library, which includes use of the key word NATIVE.

The sample interface 515 can be defined as a JAVA package that accesses elements of the centralized native library loader 505 through import statements 520 and that contains a class called TTmakerInterface. Since the centralized native library loader 505 is an existing JAVA package housing the NATIVE method line 514, import statements 520 can be used as the mechanism that allows the interface 515 to access the NATIVE method 514 without causing the TTmaker class to attempt to load the native code library.

The TTmakerInterface class can define a JAVA method 522 that encapsulates the NATIVE method 514 of the centralized native library loader 505. Thus, a JAVA plug-in can utilize the method 522 of the interface 515 to access the ImportMTs procedure of the eclipsebridge native code library. For example, the plug-in can call TTmakerInterface.ImportMTs( ) to access the ImportMTs procedure of the eclipsebridge library.

It should also be noted that the interface 515 provides a logical delineation between the call to the NATIVE method 514 and the JAVA plug-in.

As shown in this example, the abstraction module 525 can be defined as a JAVA package that defines a WTXPluginInitializer class. The WTXPluginInitializer class can include a static declaration 530 of a WTXPluginInitializer class object and a method 535 called GetsItsInstance. The static declaration 530 can ensure that the WTXPluginInitializer object is set to a value of NULL when instantiated and that the object is not cleaned up by the automatic JAVA garbage collection.

The GetsItsInstance method 535 can contain JAVA code that loads the native code library. This method 535 can include a control structure 540 that only executes the native library load of line 545 when the WTXPluginInitializer object is still set to NULL.

It should be noted that line 545 of the native library plug-in initializer 525 is identical to line 512 of the centralized native library loader 505. Both of these lines represent the manner in which a native library is loaded in the JAVA programming language. However, it is the structure of the JAVA packages, classes, and/or methods that invoke line 545 that enable the native code library to be shared among multiple plug-ins.

The diagrams in FIGS. 1-5 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for sharing a compiled native code module with interpreted modules executing in a virtual machine environment comprising:
an abstraction module digitally stored in a computer accessible medium and written in an interpreted language for a virtual machine that an interpreter of the virtual machine is configured to utilize, said abstraction module comprising programmatic code causing the interpreter to load an instance of a native module written in a compiled language so that the dependency information associated with the instance is exposed to the abstraction module; and
a plurality of interpreted code modules digitally stored in a computer accessible medium and written in the interpreted language, said interpreted code module comprising programmatic code causing the interpreter to interact with a single instance of the native module through the abstraction module, wherein the abstraction module is configured to provide the exposed dependency information associated with the single instance to each of the interpreted code modules.

2. The system of claim 1, further comprising:
a dynamic link library (DLL) comprising compiled version of the native module; and
a standardized published interface of the interpreted language configured to interface with an instance of the DLL, wherein said abstraction module is configured to utilize the standardized published interface.

3. The system of claim 2, wherein the virtual machine is a JAVA virtual machine, wherein the interpreted language is a JAVA based language, wherein the standardized published interface is a JAVA NATIVE INTERFACE (JNI).

4. The system of claim 2, wherein each of the interpreted code modules are JAVA based plug-in software components.

5. The system of claim 2, wherein each of the interpreted code modules require access to the DLL, said system further comprising:
a plurality of classloaders of the virtual machine each configured to load one of the interpreted code modules;
a plurality of classloaders of the virtual machine each configured to load the abstraction module; and
a native code library loader configured to interface with the native module with a corresponding JAVA method qualified with a NATIVE key word, wherein the abstraction module is configured to utilize the native code library loader, and wherein each of the interpreted code modules are configured to interface with the native module via the abstraction module without requiring each interpreted code module to utilize the native code library loader.

6. A method for sharing compiled native code with a plurality of interactive interpreted code modules comprising:
identifying a plurality of interpreted code modules configured to be executed within a virtual machine, wherein each of said interpreted code modules is written in an interpreted language that an interpreter of the virtual machine is configured to utilize;
identifying a native module comprising compiled native code, wherein each of the interpreted code modules are configured to interact with the native module, wherein dependency information for the native module is programmatically utilized by each of the interpreted code modules;
establishing an abstraction module for the virtual machine written in the interpreted language;
configuring the abstraction module to load an instance of the native module, wherein upon loading the instance of the native module the abstraction module is exposed to the dependency information associated with the instance of the native module; and
configuring each of the interpreted code modules to interact with the native mode module through the abstraction module, wherein the abstraction module is configured to provide the dependency information associated with the instance of the native module to each of the interpreted code modules.

7. The method of claim 6, further comprising:
utilizing a standardized published interface of the interpreted language to interface with the compiled native code.

8. The method of claim 6, wherein the virtual machine is a JAVA virtual machine, and wherein the interpreted language is a JAVA based language.

9. The method of claim 8, wherein the compiled native code is written in at least one of a C, C++, or C# based language.

10. The method of claim 8, further comprises:
utilizing a JAVA NATIVE INTERFACE (JNI) to permit the native code module to interface with the JAVA virtual machine.

11. The method of claim 10, further comprising:
enumerating dependencies among the interpreted code modules and the abstraction module via metadata.

12. The method of claim 10, wherein the native module is associated with a dynamic link library (DLL) written in a language of the native module, wherein the abstraction module loads an instance of the DLL when loading the instance of the native module, wherein abstraction module is utilized to share a single instance of the DLL including related dependencies with each of the interpreted code modules

13. The method of claim 10, wherein at least one of the interpreted code modules and the abstraction module is a PLUG-IN.

14. The method of claim 6, further comprising:
configuring the abstraction module to utilize a native code library loader when loading the native module, wherein the loading of the native module utilizes a method of the interpreted language qualified with a NATIVE key word, wherein the interpreted code modules are configured to interact with the native code module through the abstraction module in a manner in which neither of the interpreted code modules utilize a method of the interpreted language qualified with the NATIVE key word, and wherein said NATIVE key word is a standard, published reserved word of the interpreted language
